(19) United States
(12) Patent Application Publication
(10) Pub. No.: US 2025/0110888 A1
(43) Pub. Date: Apr. 3, 2025

(54) SYSTEMS AND METHODS FOR REDUCING WRITE BUFFER SIZE IN NON-VOLATILE STORAGE DEVICES

(71) Applicant: Kioxia Corporation, Tokyo (JP)

(72) Inventors: Nigel David Horspool, Milton (GB); Brian Clarke, Milton (GB)

(73) Assignee: Kioxia Corporation, Tokyo (JP)

(21) Appl. No.: 18/477,015

(22) Filed: Sep. 28, 2023

(51) Int. Cl. G06F 12/0897

(52) U.S. Cl. CPC G06F 12/0897; G06F 2212/1032; G06F 2212/2022

(57) ABSTRACT

A system may include a controller, a write buffer, and a device. The device may include a non-volatile memory (NVM), a first data buffer, and a second data buffer. The controller may be configured to transfer data from the write buffer to the first data buffer and the second data buffer and determine whether a power failure occurs. In response to determining that a power failure does not occur, the controller may configure the device to program data stored in at least one of the first data buffer or the second data buffer to the NVM in a first mode. In response to determining that the power failure occurs, the controller may configure the device to program data stored in at least one of the first data buffer or the second data buffer to the NVM in a second mode different from the first mode.

### TECHNICAL FIELD

The arrangements described herein relate generally to operating a data storage device using a write buffer for data transfer to a non-volatile memory, and more particularly to reducing a size of a write buffer using buffers in non-volatile memory devices.

### BACKGROUND

Storage devices can read from, or write to, data blocks to a non-volatile memory via volatile memory buffers. Upon detecting a power failure, a storage device can perform a power loss protection (PLP), for example, write data temporarily saved in a buffer to be persisted to a non-volatile memory. Given limited time and power during a power failure, improvements in time-and-energy efficient PLP operations remain desired.

### SUMMARY

The present arrangements relate to systems and methods for reducing a size of a write buffer in a data storage device using buffers in non-volatile memory devices.

According some arrangements, a system includes a controller, a write buffer, and a device. The device may include a non-volatile memory (NVM), a first data buffer, and a second data buffer. The controller may be configured to determine whether a power failure occurs. In response to determining that a power failure does not occur, the controller may configure the device to program data stored in at least one of the first data buffer or the second data buffer to the NVM in a first mode. In response to determining that the power failure occurs, the controller may configure the device to program data stored in at least one of the first data buffer or the second data buffer to the NVM in a second mode different from the first mode.

According to some arrangements, a method includes transferring, by the controller, data from a write buffer to a first data buffer of a device and a second data buffer of a device. The method includes determining, by the controller, whether a power failure occurs. The method may include in response to determining that a power failure does not occur, configuring, by the controller, the device to program data stored in at least one of the first data buffer or the second data buffer to a non-volatile memory (NVM) of the device in a first mode. The method may include in response to determining that the power failure occurs, configuring, by the controller, the device to program data stored in at least one of the first data buffer or the second data buffer to the NVM of the device in a second mode different from the first mode.

### BRIEF DESCRIPTION OF THE DRAWINGS

These and other aspects and features of the present arrangements will become apparent to those ordinarily skilled in the art upon review of the following description of specific arrangements in conjunction with the accompanying figures, wherein:

FIG. 1 is a block diagram illustrating an example computer system including a solid-state drive (SSD);

FIG. 2 is a block diagram illustrating an example computer system including a controller system-on-chip (SoC) in an SSD, according to some arrangements;

FIG. 3 is a block diagram illustrating an example computer system including a controller SoC and buffers in NAND sub-systems in an SSD, according to some arrangements;

FIG. 4A and FIG. 4B are diagrams showing performance of a write buffer when using buffers in NAND sub-systems, according to some arrangements; and

FIG. 5 is a flowchart illustrating an example methodology for reducing the size of a write buffer using buffers in NAND sub-systems, according to some arrangements.

### DETAILED DESCRIPTION

Some arrangements in the present disclosure relate to techniques for reducing a size of a write buffer in a data storage device using buffers in non-volatile memory devices.

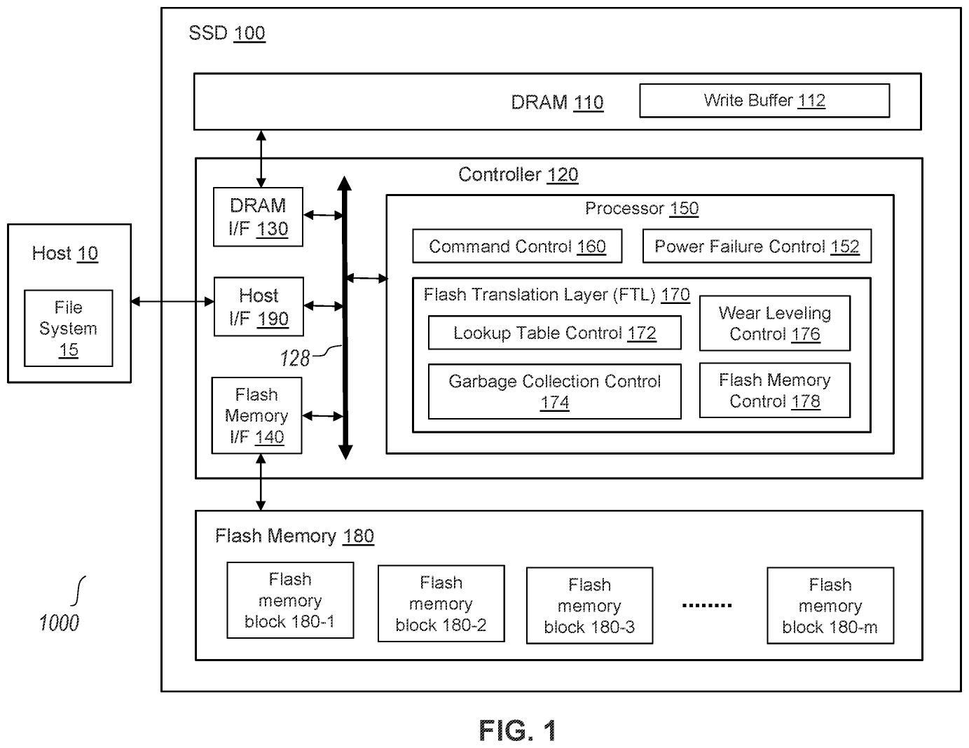

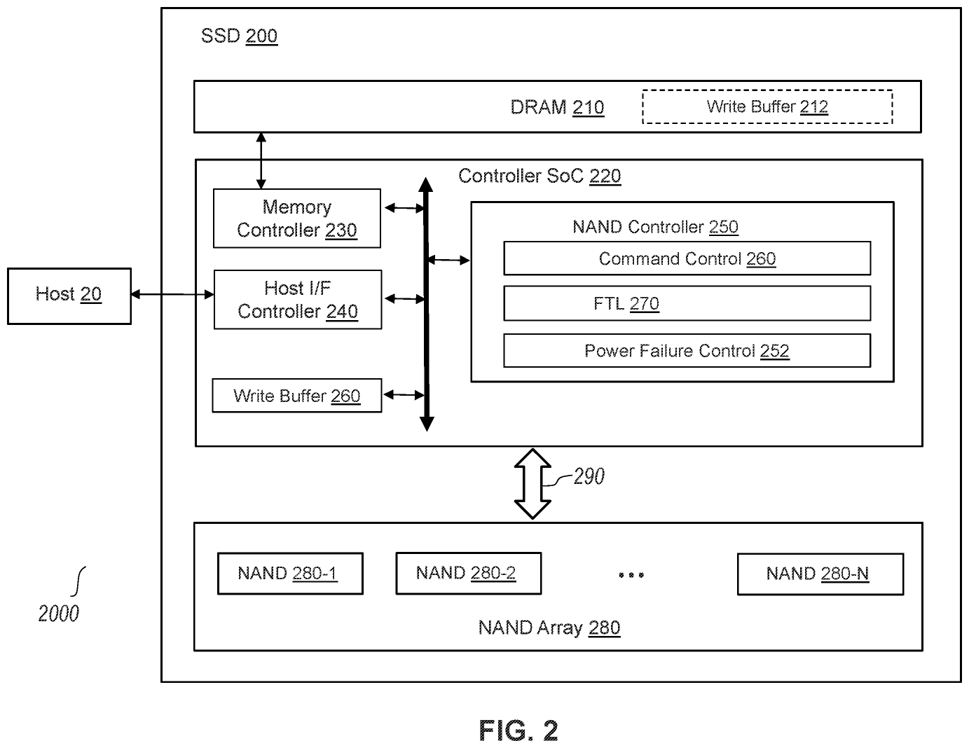

In some arrangements, data centers and enterprise servers may have PLP capacitors to be used during a sudden external power loss (e.g., power outage, power failure). The PLP capacitors can ensure that upon a power loss to solid-state drives (SSDs), for all host write commands that have been acknowledged, the write data temporarily saved and/or buffered in a volatile memory is persisted to a non-volatile memory (e.g., NAND) using PLP capacitor power. Many PLP capacitors are used to store an amount of write data that can be stored in the volatile memory. A “write buffer” may refer to an area of a volatile memory temporarily storing the write data. The size of the write buffer may sometimes limit the performance of a storage device (e.g., SSD) and impact the latency of host write data. FIG. 1 and FIG. 2 show configurations in which SSDs use one or more write buffers for data transfer to a non-volatile memory.

FIG. 1 is a block diagram illustrating an example computer system according to some arrangements. Referring to FIG. 1, a computer system 1000 may include a host 10 and an SSD 100, which is a storage device and may be used as a main storage of an information processing apparatus (e.g., the host 10). The SSD 100 may be incorporated in the information processing apparatus or may be connected to the information processing apparatus via a cable or a network.

The host 10 may be an information processing apparatus (computing device) that accesses the SSD 100. The host 10 may be a server (storage server) that stores a large amount of various data in the SSD 100, or may be a personal computer. The host includes a file system 15 used for controlling file operation (e.g., creating, saving, updating, or deleting). For example, ZFS, Btrfs, XFS, ext 4, or NTFS may be used as the file system 15. Alternatively, a file object system (e.g., Ceph Object Storage Daemon) or a key value store system (e.g., RocksDB) may be used as the file system 15.

The SSD 100 includes, for example, a controller 120 and a flash memory 180 as non-volatile memory (e.g., a NAND type flash memory). The SSD 100 may include a random access memory which is a volatile memory, for example, DRAM (Dynamic Random Access Memory) 110. In some arrangements, the controller 120 may include a random access memory such as SRAM (Static Random Access Memory). The random access memory such as the DRAM 110 has, for example, a read buffer which is a buffer area for temporarily storing data read out from the flash memory 180, a write buffer 112 which is a buffer area for temporarily storing data written in the flash memory 180, and a buffer used for a garbage collection. In some arrangements, the controller 120 may include the DRAM 110.

In some arrangements, the flash memory 180 may include a memory cell array which includes a plurality of flash memory blocks (e.g., NAND blocks) 180-1 to 180-m. Each of the blocks 180-1 to 180-m may function as an erase unit. Each of the blocks 180-1 to 180-m includes a plurality of physical pages. In some arrangements, in the flash memory 180, data reading and data writing are executed on a page basis, and data erasing is executed on a block basis.

In some arrangements, the controller 120 may be a memory controller configured to control the flash memory 180. The controller 120 includes, for example, a processor (e.g., CPU) 150, a flash memory interface 140, and a DRAM interface 130, a host interface 190, all of which may be interconnected via a bus 128. The DRAM interface 130 may function as a DRAM controller configured to control an access to the DRAM 110. The flash memory interface 140 may function as a flash memory control circuit (e.g., NAND control circuit) configured to control the flash memory 180 (e.g., NAND type flash memory).

The host interface 190 may function as a circuit which receives various requests from the host 15 and transmits responses to the requests to the host 10. The requests may include various commands such as an I/O command and a control command. The I/O command may include, for example, a write command, a read command, a trim command (unmap command), a format command, and a flush command. The write command is also called a program command. The format command may be a command for unmapping the entire memory system (SSD 100).

The processor 150 may be configured to control the flash memory interface 140, and the DRAM interface 130. The processor 150 may be configured to perform various processes by executing a control program (e.g., firmware) stored in, for example, a ROM (not shown). In some arrangements, the processor 150 may perform a command control 160 to execute command processing for processing various commands received from an information processing apparatus (e.g., a host computer). In some arrangements, the processor 150 may perform a power failure control 152 to detect a power failure and/or execute PLP operations, e.g., writing and/or persisting write data temporarily saved and/or buffered in the write buffer 112 to a non-volatile memory (e.g., NAND) using PLP capacitor power. The processor 150 may be configured to function as a flash translation layer (FTL) 170 to execute data management and block management of the flash memory 180. The FTL 170 may include a look-up table control 172, a garbage collection control 174, a wear leveling control 176, and a flash memory control 178. The data management may include management of mapping information indicating a correspondence relationship between a logical address (e.g., LBA (logical block address)) and a physical address of the flash memory 180. In some arrangements, the look-up table control 172 may execute management of mapping between (1) each logical block address (LBA) or each logical page address and (2) each physical address using an address translation table (logical/physical address translation table). The garbage collection control unit 174 may execute garbage collection (GC) which is a process executed to generate a free block as a data write destination block. The wear leveling control 176 may execute wear leveling which is a process of leveling the number of times of block erasure so that by preventing an occurrence of blocks with a larger number of erasures, the failure probability of the SSD 100 can be reduced. The flash memory control unit 178 may execute control of the flash memory interface 140.

FIG. 2 is a block diagram illustrating an example computer system 2000 including a controller system-on-chip (SoC) 220 in an SSD 200, according to some arrangements. The computer system 2000 may include a host 20 which may have configuration similar to that of host 10 (see FIG. 1). The SSD 200 is a storage device and may be used as a main storage of an information processing apparatus (e.g., the host 20). The SSD 200 may be incorporated in the information processing apparatus or may be connected to the information processing apparatus via a cable or a network. The SSD 200 may include DRAM 210 and a NAND array 280. DRAM 210 has configuration similar to that of DRAM 110. For example, DRAM 210 may include a write buffer 212. The NAND array 280 may include a plurality of NAND-type flash memory 280-1, 280-2, . . . , 280-N (e.g., N=16, . . . , 128, etc.). The controller SoC 220 may read data from, or write data to, the NAND array through a NAND bus 290 (e.g., 8-bit or 16 bit data bus).

The controller SoC 220 may be a system-on-chip or an integrated circuit that integrates a NAND controller 220, a memory controller 230, a host I/F controller 240, and a volatile memory including a write buffer 260. The typical write buffer size (including the write buffers 212 and 260) may be at least 6 MB (as a minimum). Each of the NAND controller 220, the memory controller 230, and the host I/F controller 240 may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein.

The NAND controller 250 may function similar to the processor 150 and/or the flash memory I/F 140 (see FIG. 1). For example, the NAND controller may perform a command control 260 to execute command processing for processing various commands received from an information processing apparatus (e.g., a host computer). In some arrangements, the NAND controller may perform a power failure control 252 to detect a power failure (e.g., by monitoring voltages) and/or execute PLP operations, e.g., writing and/or persisting write data temporarily saved and/or buffered in the write buffer 260 to a non-volatile memory (e.g., NAND) using PLP capacitor power. The NAND controller may be configured to function as a flash translation layer (FTL) 270 to execute data management and block management of the flash memory (e.g., NAND-type flash memory) in the NAND array 280. The NAND controller 250 may be configured to control transfer of data flows in multiple channels (e.g., 16 channels) to or from the NAND array 280 in parallel (through the NAND bus 290). The NAND controller 250 may be configured to perform error correction to extract correct data from data read from the NAND array 280.

The memory controller 230 may function similar to the DRAM I/F 130 (see FIG. 1). For example, the memory controller may manage temporary data buffers (e.g., write buffer 212) for transfer of read/write data and manage look-up table (LUT) data (which may take up 90% of DRAM data). The host interface controller 240 may function similar to the host I/F 190 (see FIG. 1). In some arrangements, the host interface controller 240 may implement one or more storage access protocols including peripheral component interconnect express (PCIe) and/or NVMe (nonvolatile memory express).

In one aspect, the size of a write buffer (e.g., write buffer 260 in FIG. 2) may be one of the key elements that limit the host I/O write command performance of an SSD (e.g., SSD 200 in FIG. 2). For example, smaller write buffers may reduce the write performance. Different storage access protocols may use different sizes of write buffers. For example, NVMe multi-stream SSDs may use larger write buffers compared to a standard NVMe SSD to achieve the same aggregate I/O write performance.

Generally, as the SSD capacity increases, the size of the write buffer may increase to improve the write performance. However, in case of power loss or failure, smaller write buffers can use fewer PLP capacitors for power loss protection. Moreover, the data saved in a write buffer can be programmed in NAND sub-systems (e.g., TLC programming), and the data can be deleted from the write buffer as soon as the data has been transferred to the NAND (e.g., using a method called “fire-and-forget FTL”). In case of power loss, the data transferred from the write buffer to the NAND must complete TLC programming which consumes a large amount of energy. Therefore, the use of larger write buffers may consume more energy than the use of smaller write buffers. The write buffers can be made smaller, which may reduce the write performance. There is a general problem of reducing the size of a write buffer to reduce the amount energy used to store in-flight host write command data without impacting the write performance.

To solve this problem, according to certain aspects, arrangements in the present disclosure relate to techniques for limiting or reducing the size of a write buffer in a non-volatile storage device (e.g., SSD) to reduce the amount of energy used to store in-flight write commands on a power failure, without impacting the I/O write command performance of the SSD. In some arrangements, an SSD may include one or more write buffers and a flash memory controller system-on-chip (SoC) (e.g., NAND controller SoC). The majority of the one or more write buffers may be located within the NAND controller SoC to improve the performance of the SSD. In some arrangements, the SSD may be a multi-stream (or multi-streamed) SSD which can write data in a stream together to a physically related NAND flash spaces (e.g., blocks or erase units) and also separate the data from data in other streams. The size of the write buffer may be critical to the host I/O write command performance of SSDs (e.g., datacenter SSDs), particularly for NVMe multi-stream SSDs.

In some arrangements, the storage device may include one or more flash memory devices (e.g., NAND sub-systems). The NAND sub-systems can include at least one of types of NAND including single-level cell (SLC) type, multi-level cell (MLC) type, triple-level cell (TLC) type, or quad-level cell (QLC) type. The NAND sub-systems may support or maintain at least two data buffers—(1) a program data buffer (also referred to as “program buffer,” “P-buffer,” “current program full sequence programming (FSP) data buffer”) and (2) an additional data buffer (also referred to as “additional buffer,” “A-buffer,” “queued program FSP data buffer”). For example, each NAND sub-system may have a 192 KB A-buffer. If the number of NAND sub-systems is 128, the total size of the A-buffers will be 24 MB. Each NAND sub-system may include NAND memory, one or more P-buffers, one or more A-buffers. In some arrangements, each NAND sub-system may be an integrated circuit or a chip. The use of the P-buffer and the A-buffer can allow data to be quickly transferred from the controller (e.g., NAND controller SoC) so that the write buffer can be made as small as possible, without impacting the I/O write command performance of the storage device. The use of the P-buffer and the A-buffer can reduce the size of the write buffer, thereby reducing the amount of energy used to store in-flight host write command data without impacting the I/O write performance. The use of the A-buffer can also reduce time between the completion of one NAND program command and starting the next programming operation as the data for that program has already been received from the host and transferred to the NAND.

In some arrangements, a P-buffer may include a plurality of P-buffers. An A-buffer may include a plurality of A-buffers. A P-buffer and an A-buffer may form a buffer queue (e.g., first-in-first-out (FIFO) queue). A P-buffer and an A-buffer may form a ping pong buffer (or multiple buffering) so that data in one of the P-buffer and the A-buffer can be written to NAND while data being received by the other of the P-buffer and the A-buffer.

In some arrangements, the storage device can support a “power-loss-reset” command to immediately stop all programs to a NAND sub-system or a NAND array including a plurality of NAND sub-systems. For example, upon receiving the “power-loss-reset” command, the storage may stop all programming to the NAND array in an SLC mode, an MLC mode, a TLC mode, or a QLC mode.

In some arrangements, the storage device can support a “power-loss-flush” command to trigger or start programming of any host in-flight data stored in a P-buffer and/or an A-buffer of a NAND sub-system to the NAND memory of the NAND sub-system. For example, upon receiving the “power-loss-flush” command, the storage device may program (or control each NAND sub-system to program) the host in-flight data stored in the P-buffer and/or the A-buffer to an empty block in a pseudo single-level cell (pSLC) mode. The pSLC mode is significantly faster to program the data than other modes (e.g., MLC, TLC, or QLC mode), thereby reducing the energy used to store the host in-flight data in the NAND array. The data can be programmed using the P-buffer and/or A-buffer of a NAND sub-system, thereby (1) allowing the controller (e.g., controller SoC) not to process nor to transfer the data to the NAND sub-system and (2) saving the energy to create NAND parity and to transfer the data to the NAND sub-system.

In some arrangements, the storage device may add an A-buffer to a NAND sub-system (e.g., each NAND sub-system in the NAND array) and add extra NAND commands (e.g., “power-loss-reset” followed by “power-loss-flush”) to allow the data stored in both the A-buffer and the P-buffer to be programmed in an empty block in the pSLC mode without having to transfer the data from the write buffer (e.g., write buffer in an SSD controller SoC) through the controller (e.g., SSD controller SoC), across a NAND bus to the NAND sub-system. In this manner, the storage device can split a buffer size (e.g., the size of a write buffer) between (1) a controller and DRAM and (2) NAND sub-systems. When there is a power loss (or a power loss is detected), the storage device can allow the controller to immediately stop all programming in the NAND array (in MLC, TLC, or QLC mode), while identifying which data stored in the NAND buffers (e.g., P-buffer and/or A-buffer) are to be programmed in the pSLC mode. In some arrangements, the data stored in the P-buffer and/or the A-buffer and then programmed in the pSLC mode may include host write data, and may not include garbage collection data. Immediately stopping in progress programs (in MLC, TLC, or QLC mode) can maximize the amount of data programmed in the pSLC mode, and programming from the internal NAND buffers (e.g., P-buffer and/or A-buffer) can reduce the amount of energy used to store this data compared to an approach which allows in-progress programming to complete and then transfer remaining data from the write buffer in the controller and/or DRAM. In some arrangements, when power comes back, the storage device can read data programmed in the pSLC mode and write (e.g., re-program) the data in the original programming mode (e.g., TLC mode).

In some arrangements, the storage device can transfer data to one of the P-buffer and the A-buffer of a NAND sub-system, while the current NAND programming (e.g., in the TLC/QLC mode) is in operation in the other of the P-buffer and the A-buffer, thereby maximizing the NAND programming rate and freeing-up space in the write buffer in the controller and/or an internal memory (e.g., DRAM) which can improve the write performance with a small amount or size of the internal RAM. The use of the P-buffer and the A-buffer of each NAND sub-system can have an effect of increasing the size of the write buffer automatically as the number of NAND sub-systems increases. That is, the more the NAND sub-systems become, the larger the write buffer can be realized, achieved or implemented by the P-buffer and the A-buffer (in the volatile memory in the NAND sub-systems).

In one approach, a system may include a controller, a write buffer, and a device. The device may include a non-volatile memory (NVM), a first data buffer, and a second data buffer. The controller may be configured to transfer data from the write buffer to the first data buffer and the second data buffer and determine whether a power failure occurs. In response to determining that a power failure does not occur, the controller may configure the device to program data stored in at least one of the first data buffer or the second data buffer to the NVM in a first mode. In response to determining that the power failure occurs, the controller may configure the device to program data stored in at least one of the first data buffer or the second data buffer to the NVM in a second mode different from the first mode.

In some arrangements, the first mode may be at least one of single-level cell (SLC) mode, multi-level cell (MLC) mode, triple-level cell (TLC) mode, or quad-level cell (QLC) mode. The second mode may be a pseudo single-level cell (pSLC) mode. The controller may include the write buffer. For example, in response to determining that the power failure occurs, remaining in-flight write data can be transferred from the write buffer to NAND buffers (e.g., first buffer, second buffer) in parallel with a flush operation of other NAND buffers (e.g., first buffer, second buffer) into a special pSLC storage area. In some arrangements, a flush operation can be executed and then remaining inflight data in the write buffer can be transferred to the NAND for programming into a special pSLC storage area.

In some arrangements, the device may include a plurality of sub-systems each including a respective NVM. The first data buffer may include one or more program data buffers in each of the plurality of sub-systems. The second data buffer may include one or more additional buffers in each of the plurality of sub-systems. In some arrangements, the controller is a solid state drive (SSD) controller system-on-chip (SoC).

In some arrangements, the controller may be configured to transfer data from the write buffer to the one or more program data buffers and the one or more additional data buffers of a first sub-system of the plurality of sub-systems. In response to determining that the power failure does not occur, the controller may configure the first sub-system to program, to the NVM of the first sub-system in the first mode, data stored in at least one of the one or more program data buffers or the one or more additional data buffers of the first sub-system of the plurality of sub-systems. In response to determining that the power failure occurs, the controller may configure the first sub-system to program, to the NVM of the first sub-system in the second mode, data stored in in at least one of the one or more program data buffers or the one or more additional data buffers of the first sub-system.

In some arrangements, in response to transferring the data from the write buffer to the first data buffer and the second data buffer, the controller may be configured to delete the data from the write buffer. In response to determining that the power failure occurs, the device may be configured to stop the programming in the first mode, and then start programming the data stored in the first data buffer to the NVM in the second mode. In response to determining that the power failure occurs, the controller is configured to program data stored in the write buffer to the NVM in the second mode, while programming the data stored in at least one of the first data buffer or the second data buffer to the NVM in the second mode.

Arrangements in the present disclosure have at least the following advantages and benefits. First, arrangements in the present disclosure can provide useful techniques for reducing the size of a write buffer in a storage device. The use of NAND buffers (e.g., P-buffer and A-buffer) can allow data to be quickly transferred from the controller (e.g., NAND controller SoC) so that the write buffer can be made as small as possible, without impacting the I/O write command performance of the storage device. The use of NAND buffers (e.g., P-buffer and A-buffer) can also allow data to be transferred from the P-buffer and A-buffer to pSLC cells, thereby offering lower power due to no need to transfer from the write buffer through the NAND controller SoC to the NAND over external buses (e.g., NAND bus).

Second, arrangements in the present disclosure can provide useful techniques for reducing the energy used to store the host in-flight data in the NAND array. First, the use of the P-buffer and the A-buffer can reduce the size of the write buffer, thereby reducing the amount of energy used to store in-flight host write command data without impacting the I/O write performance. Second, the storage device can program the host in-flight data stored in NAND buffers (e.g., P-buffer and/or A-buffer) to an empty block in the pSLC mode. The pSLC mode is significantly faster to program the data than other modes (e.g., MLC, TLC, or QLC mode), thereby reducing the energy used to store the host in-flight data in the NAND array.

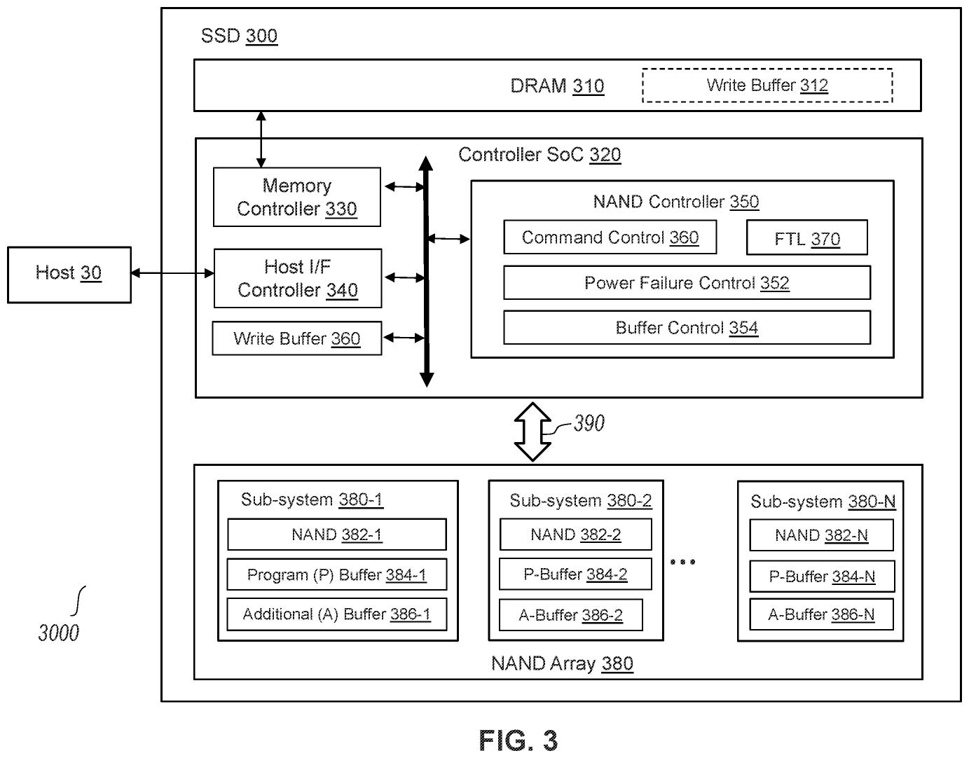

FIG. 3 is a block diagram illustrating an example computer system 3000 including a controller SoC 320 and buffers (e.g., program buffers, additional buffers) in NAND sub-systems (e.g., NAND sub-systems 380-1, 380-2, . . . , 380-N in a NAND array (or NAND device or NAND sub-systems) 380) in an SSD 300, according to some arrangements. The computer system 3000 may include a host 20 which may have configuration similar to that of host 20 (see FIG. 2). The SSD 300 is a storage device and may be used as a main storage of an information processing apparatus (e.g., the host 30). The SSD 300 may be incorporated in the information processing apparatus or may be connected to the information processing apparatus via a cable or a network. The SSD 300 may include DRAM 310 and a NAND array (or NAND device) 380. DRAM 310 has configuration similar to that of DRAM 210. For example, DRAM 310 may include a write buffer 312. The NAND array 380 may include a plurality of sub-systems (e.g., NAND sub-systems 380-1, 380-2, . . . , 380-N; N=16, . . . , 128, etc.). Each device may include respective NAND-type flash memory 382-1, 382-2, . . . , 382-N, a respective program buffer (“P-buffer”) 384-1, 384-2, . . . , 384-N, and a respective additional buffer (“A-buffer”) 386-1, 386-2, . . . , 386-N. The respective P-buffer and the respective A-buffer may be included in a volatile memory. In some arrangements, each device may include a respective processor (e.g., CPU) and/or a respective non-volatile memory (not shown), and the respective P-buffer and the respective A-buffer may be included in the respective volatile memory. The controller SoC 320 may read data from, or write data to, the NAND array 380 through a NAND bus 390 (e.g., 8-bit or 16 bit data bus).

The controller SoC 320 may be a system-on-chip or an integrated circuit that integrates a NAND controller 320, a memory controller 330, a host I/F controller 340, and a volatile memory including a write buffer 360, each of which may be implemented or performed with a general purpose processor, a DSP, an ASIC, an FPGA or other programmable logic device, discrete gate or transistor logic, discrete hardware components, or any combination thereof designed to perform the functions described herein.

The NAND controller 350 may function similar to the NAND controller 250 (see FIG. 2). For example, the NAND controller 350 may perform a command control 360, a power failure control 352, a flash translation layer (FTL) 370, similar to the NAND controller 250 which performs a command control 260, a power failure control 252, a FTL 270, respectively. In some arrangements, the NAND controller 350 may be configured to perform a buffer control 354 to manage and/or control data buffers (e.g., write buffer 312, write buffer 360, P-buffers 384, A-buffers 386). The memory controller 330 may function similar to the memory controller 230 (see FIG. 2). The host interface controller 340 may function similar to the host interface controller 240 (see FIG. 2).

Referring to FIG. 3, the SSD 300 can limit or reduce the size of the write buffer (e.g., write buffer 360 or 312) to reduce the amount of energy used to store in-flight write commands on a power failure (e.g., upon detecting a power failure by power failure control 352), without impacting the I/O write command performance of the SSD. The SSD 300 may include one or more write buffers (e.g., write buffer 360 or 312) and the NAND controller SoC 320. In some arrangements, the majority of the one or more write buffers may be located within the NAND controller SoC (e.g., within the write buffer 360) to improve the performance of the SSD. The SSD 300 may be a multi-stream (or multi-streamed) SSD. The NAND sub-systems 380-1, 380-2, . . . , 380-N in the NAND array 380 can include at least one of types of NAND 382 including SLC type, MLC type, TLC type, or QLC type. The NAND sub-systems may support or maintain at least two data buffers—(1) a program data buffer (P-buffer) 384 and (2) an additional data buffer (A-buffer) 386. For example, each NAND sub-system may have a 192 KB A-buffer. If the number of NAND sub-systems is 128, the total size of the A-buffers will be 24 MB. Each NAND sub-system 380-1, 380-2, . . . , 380-N may include respective NAND memory 382-1, 382-2, . . . , 382-N, respective one or more P-buffers 384-1, 384-2, . . . , 384-N, respective one or more A-buffers 386-1, 386-2, . . . , 386-N. Each NAND sub-system may be an integrated circuit or a chip. The use of the P-buffer and the A-buffer can allow data to be quickly transferred from the NAND controller SoC 320 so that the write buffer 360 or 312 can be made as small as possible, without impacting the I/O write command performance of the SSD 300. The use of the P-buffer and the A-buffer can reduce the size of the write buffer, thereby reducing the amount of energy used to store in-flight host write command data without impacting the I/O write performance.

In some arrangements, a P-buffer (e.g., P-buffer 384-1) may include a plurality of P-buffers. An A-buffer (e.g., A-buffer 386-1) may include a plurality of A-buffers. A P-buffer and an A-buffer may form a buffer queue (e.g., FIFO queue). A P-buffer and an A-buffer may form a ping pong buffer (or multiple buffering) so that data in one of the P-buffer and the A-buffer can be written to NAND while data being received by the other of the P-buffer and the A-buffer.

In some arrangements, the SSD 300 (e.g., controller SoC 320, NAND controller 350, command control 360, buffer control 354) can support a “power-loss-reset” command to immediately stop all programs to the NAND array 380 including a plurality of NAND sub-systems 380-1, 380-2, . . . , 380-N. For example, upon receiving the “power-loss-reset” command, the SSD 300 may stop all programming to the NAND array in an SLC mode, an MLC mode, a TLC mode, or a QLC mode. The SSD 300 (e.g., NAND controller 350, command control 360, buffer control 354) can support a “power-loss-flush” command to trigger or start programming of any host in-flight data stored in a P-buffer 384 and/or an A-buffer 386 of a NAND sub-system to the NAND memory 382 of the NAND sub-system. For example, upon receiving the “power-loss-flush” command, the SSD 300 may program (or control each NAND sub-system to program) the host in-flight data stored in the P-buffer 384 and/or the A-buffer 386 to an empty block in a pSLC mode. The pSLC mode is significantly faster to program the data than other modes (e.g., MLC, TLC, or QLC mode), thereby reducing the energy used to store the host in-flight data in the NAND array 380. The data can be programmed using the P-buffer and/or A-buffer of a NAND sub-system, thereby (1) allowing controller SoC 320 not to process nor to transfer the data to the NAND device (or NAND array) 380 and (2) saving the energy to create NAND parity and to transfer the data to the NAND device 380.

By adding an A-buffer to a NAND sub-system (e.g., each NAND sub-system in the NAND array) and adding extra NAND commands (e.g., “power-loss-reset” followed by “power-loss-flush”), the data stored in both the A-buffer and the P-buffer can be programmed in an empty block in the pSLC mode without having to transfer the data from the write buffer 360, 312 through the controller SoC 320, across the NAND bus 390 to the NAND device (or NAND array) 380. In this manner, the SSD 300 can split a buffer size (e.g., the size of a write buffer) between (1) the controller 320 and DRAM 310 and (2) NAND sub-systems 380. When there is a power loss (or a power loss is detected), the SSD 300 (e.g., controller SoC 320, NAND controller 350, command control 360, buffer control 354) can allow the controller 320 to immediately stop all programming in the NAND array 380 (in MLC, TLC, or QLC mode), while identifying which data stored in the NAND buffers (e.g., P-buffer 384 and/or A-buffer 386) are to be programmed in the pSLC mode. The data stored in the P-buffer and/or the A-buffer and then programmed in the pSLC mode may include host write data, and may not include garbage collection data. Immediately stopping in progress programs (in MLC, TLC, or QLC mode) can maximize the amount of data programmed in the pSLC mode, and programming from the internal NAND buffers (e.g., P-buffer and/or A-buffer) can reduce the amount of energy used to store this data compared to an SSD (e.g., SSD 200 in FIG. 2) which allows in-progress programming to complete and then transfer remaining data from the write buffer in the controller and/or DRAM. In some arrangements, when power comes back, the SSD 300 (e.g., controller SoC 320, NAND controller 350, command control 360, buffer control 354) can read data programmed in the pSLC mode and write (e.g., re-program) the data in the original programming mode (e.g., TLC mode).

In some arrangements, the SSD 300 can transfer data to one of the P-buffer 384 and the A-buffer 386 of a NAND sub-system 380, while the current NAND programming (e.g., in the TLC/QLC mode) is in operation in the other of the P-buffer and the A-buffer, thereby maximizing the NAND programming rate and freeing-up space in the write buffer in the controller 320 and/or an internal memory (e.g., DRAM 310) which can improve the write performance with a small amount or size of the internal memory. The use of the P-buffer and the A-buffer of each NAND sub-system can have an effect of increasing the size of the write buffer automatically as the number of NAND sub-systems increases. That is, the more the NAND sub-systems become, the larger the write buffer can be realized, achieved or implemented by the P-buffer and the A-buffer (in the volatile memory in the NAND sub-systems). For example, if the size of an A-buffer is a 192 KB and the number of NAND sub-systems is 128, this can have an effect of increasing the total size of the write buffer by 24 MB.

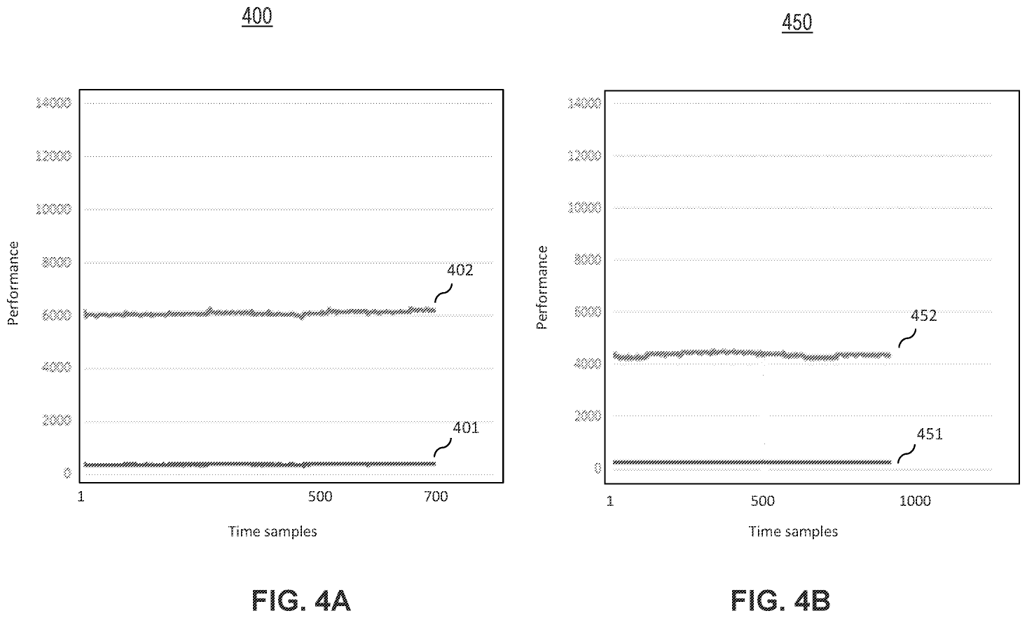

FIG. 4A and FIG. 4B are diagrams showing performance of a write buffer when using buffers in NAND sub-systems, according to some arrangements. FIG. 4A shows the performance of the write buffer over time samples when multiple data streams (e.g., 16 streams) are transferred using a storage device (e.g., SSD 300 in FIG. 3) that uses NAND buffers (e.g. A-buffer) and pSLC programming upon a power failure. In FIG. 4A, the lines 401 represent the performance of the write buffer used for transferring individual 16 streams, while the line 402 represents the performance of the write buffer used for transferring an aggregated stream aggregating the 16 streams. FIG. 4B shows the performance of the write buffer over time samples when multiple data streams (e.g., 16 streams) are transferred using a storage device (e.g., SSD 300 in FIG. 3) that does not use NAND buffers (e.g. A-buffer) nor pSLC programming upon a power failure. In FIG. 4B, the lines 451 represent the performance of the write buffer used for transferring individual 16 streams, while the line 452 represents the performance of the write buffer used for transferring an aggregated stream aggregating the 16 streams. The performance shown by FIG. 4A with a larger total buffer size is higher than that shown by FIG. 4B. FIG. 4A and FIG. 4B show that with a smaller write buffer the performance is improved with the use of the additional A buffer in the NAND (see FIG. 4A) which can effectively increase the size of the write buffer, compared with a storage device that does not use the additional A buffer (see FIG. 4B). One advantage is that the write buffer effectively increases with increased number of NAND sub-systems; and the extra NAND sub-systems allow a higher write performance without increasing the size of write buffer in the internal SoC memory. If no buffers in the NAND are used and the write buffer is only in the internal SoC memory, the size of this internal memory must be sized for the largest SSD size which would increase power and cost of the SoC.

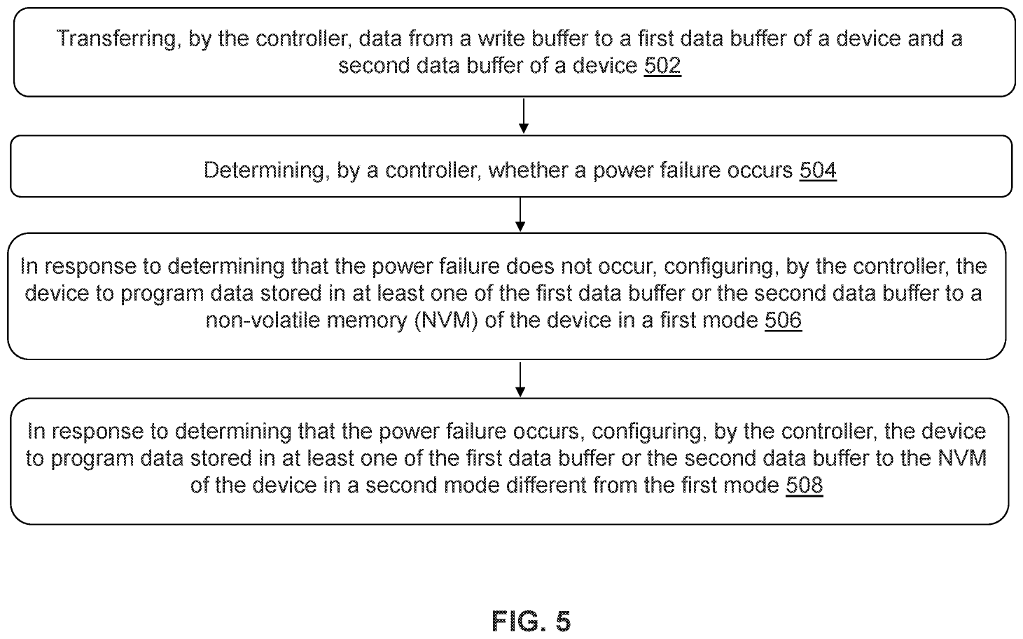

FIG. 5 is a flowchart illustrating an example methodology for reducing the size of a write buffer (e.g., write buffer 312, 360) using buffers (e.g., P-buffers 384, A-buffers 386) in NAND sub-systems (e.g., NAND sub-systems 380-1, 380-2, . . . , 380-N), according to some arrangements. In this example, the process begins in S502 by transferring, by a controller (e.g., controller SoC 320, NAND controller 350, power failure control 352), data from the write buffer (e.g., write buffer 360, 312) to a first data buffer (e.g., P-buffer 384-1, . . . , 384-N) and a second data buffer (e.g., A-buffer 386-1, . . . , 386-N) of a device (e.g., NAND device or NAND array 380). In some arrangements, the controller is a solid state drive (SSD) controller system-on-chip (SoC) (e.g., controller SoC 320). In some arrangements, in response to transferring the data from the write buffer to the first data buffer and the second data buffer, the controller may be configured to delete the data from the write buffer.

In some arrangements, the device may include a plurality of sub-systems (e.g., NAND sub-systems 380-1, 380-2, . . . , 380-N) each including a respective NVM (e.g., NAND 382-1, 382-2, . . . , 382-N). The first data buffer may include one or more program data buffers (e.g., P-buffer 384-1, . . . , 384-N) in each of the plurality of sub-systems. The second data buffer may include one or more additional buffers (e.g., A-buffer 386-1, . . . , 386-N) in each of the plurality of sub-systems. In some arrangements, the controller may be configured to transfer data from the write buffer to the one or more program data buffers and the one or more additional data buffers of a first sub-system of the plurality of sub-systems (e.g., NAND sub-system 380-1).

In S504, in some arrangements, the controller (e.g., controller SoC 320, NAND controller 350, power failure control 352) may determine whether a power failure occurs.

In S506, in some arrangements, in response to determining that a power failure does not occur, the controller may configure the device to program data stored in at least one of the first data buffer (e.g., P-buffer 384) or the second data buffer (e.g., A-buffer 386) to the NVM in a first mode. In some arrangements, the first mode may be at least one of single-level cell (SLC) mode, multi-level cell (MLC) mode, triple-level cell (TLC) mode, or quad-level cell (QLC) mode. In some arrangements, in response to determining that the power failure does not occur, the controller may configure the first sub-system to program, to the NVM (e.g., NAND 382-1) of the first sub-system (e.g., NAND sub-system 380-1) in the first mode, data stored in at least one of the one or more program data buffers (e.g., P-buffer 384-1) or the one or more additional data buffers (e.g., A-buffer 386-1) of the first sub-system of the plurality of sub-systems.

In S508, in some arrangements, in response to determining that the power failure occurs, the controller may configure the device to program data stored in at least one of the first data buffer (e.g., P-buffer 384) or the second data buffer (e.g., A-buffer 386) to the NVM in a second mode (e.g., pSLC mode) different from the first mode (e.g., SLC/TLC/QLC mode). The second mode may be a pseudo single-level cell (pSLC) mode. In response to determining that the power failure occurs, the controller may configure the first sub-system to program, to the NVM (e.g., NAND 382-1) of the first sub-system (e.g., NAND sub-system 380-1) in the second mode (e.g., pSLC mode), data stored in in at least one of the one or more program data buffers (e.g., P-buffer 384-1) or the one or more additional data buffers (e.g., A-buffer 386-1) of the first sub-system.

In some arrangements, in response to determining that the power failure occurs, the device may be configured to stop the programming in the first mode, and then start programming the data stored in the first data buffer to the NVM in the second mode (e.g., “power-loss-reset” followed by “power-loss-flush”). For example, power-loss-reset would stop any in-progress TLC/QLC programs, while power-loss-flush would program any contents of the first data buffer (e.g., P-buffer) and the second data buffer (e.g., A buffer) to NAND in pSLC mode. In response to determining that the power failure occurs, the controller may be configured to program data stored in the write buffer (e.g., other remaining uncommitted, but acknowledged, data stored in the write buffer 360) to the NVM in the second mode (e.g., pSLC mode), while programming the data stored in at least one of the first data buffer or the second data buffer (e.g., P-buffer or A-buffer) to the NVM in the second mode.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. The functions implemented in software may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A system comprising:
a controller;
a write buffer; and
a device comprising a non-volatile memory (NVM), a first data buffer, and a second data buffer,
wherein the controller is configured to:
transfer data from the write buffer to the first data buffer and the second data buffer;
determine whether a power failure occurs;
in response to determining that a power failure does not occur, configure the device to program data stored in at least one of the first data buffer or the second data buffer to the NVM in a first mode; and
in response to determining that the power failure occurs, configure the device to program data stored in at least one of the first data buffer or the second data buffer to the NVM in a second mode different from the first mode.

2. The system of claim 1, wherein the first mode is at least one of single-level cell (SLC) mode, multi-level cell (MLC) mode, triple-level cell (TLC) mode, or quad-level cell (QLC) mode.

3. The system of claim 1, wherein the second mode is a pseudo single-level cell (pSLC) mode.

4. The system of claim 1, wherein the controller comprises the write buffer.

5. The system of claim 1, wherein
the device comprises a plurality of sub-systems each comprising a respective NVM,
the first data buffer comprises one or more program data buffers in each of the plurality of sub-systems, and
the second data buffer comprises one or more additional buffers in each of the plurality of sub-systems.

6. The system of claim 5, wherein the controller is configured to:
transfer data from the write buffer to the one or more program data buffers and the one or more additional data buffers of a first sub-system of the plurality of sub-systems;
in response to determining that the power failure does not occur, configure the first sub-system to program, to the NVM of the first sub-system in the first mode, data stored in at least one of the one or more program data buffers or the one or more additional data buffers of the first sub-system of the plurality of sub-systems; and
in response to determining that the power failure occurs, configure the first sub-system to program, to the NVM of the first sub-system in the second mode, data stored in in at least one of the one or more program data buffers or the one or more additional data buffers of the first sub-system.

7. The system of claim 1, wherein the controller is configured to:
in response to transferring the data from the write buffer to the first data buffer and the second data buffer, delete the data from the write buffer.

8. The system of claim 1, wherein in response to determining that the power failure occurs, the device is configured to:
stop the programming in the first mode, and then start programming the data stored in at least one of the first data buffer or the second data buffer to the NVM in the second mode.

9. The system of claim 1, wherein in response to determining that the power failure occurs, the controller is configured to program data stored in the write buffer to the NVM in the second mode, while programming the data stored in at least one of the first data buffer or the second data buffer to the NVM in the second mode.

10. The system of claim 1, wherein the controller is a solid state drive (SSD) controller system-on-chip (SoC).

11. A method comprising:
transferring, by a controller, data from a write buffer to a first data buffer of a device and a second data buffer of a device;
determining, by the controller, whether a power failure occurs;
in response to determining that a power failure does not occur, configuring, by the controller, the device to program data stored in at least one of the first data buffer or the second data buffer to a non-volatile memory (NVM) of the device in a first mode; and
in response to determining that the power failure occurs, configuring, by the controller, the device to program data stored in at least one of the first data buffer or the second data buffer to the NVM of the device in a second mode different from the first mode.

12. The method of claim 11, wherein the first mode is at least one of single-level cell (SLC) mode, multi-level cell (MLC) mode, triple-level cell (TLC) mode, or quad-level cell (QLC) mode.

13. The method of claim 11, wherein the second mode is a pseudo single-level cell (pSLC) mode.

14. The method of claim 11, wherein the controller comprises the write buffer.

15. The method of claim 11, wherein
the device comprises a plurality of sub-systems each comprising a respective NVM,
the first data buffer comprises one or more program data buffers in each of the plurality of sub-systems, and
the second data buffer comprises one or more additional buffers in each of the plurality of sub-systems.

16. The method of claim 15, further comprising:
transferring data from the write buffer to the one or more program data buffers and the one or more additional data buffers of a first sub-system of the plurality of sub-systems;
in response to determining that the power failure does not occur, configuring the first sub-system to program, to the NVM of the first sub-system in the first mode, data stored in at least one of the one or more program data buffers or the one or more additional data buffers of the first sub-system; and
in response to determining that the power failure occurs, configuring the first sub-system to program, to the NVM of the first sub-system in the second mode, data stored in at least one of the one or more program data buffers or the one or more additional data buffers of the first sub-system.

17. The method of claim 11, further comprising:
in response to transferring the data from the write buffer to the first data buffer and the second data buffer, deleting the data from the write buffer.

18. The method of claim 11, further comprising:
in response to determining that the power failure occurs, stopping the programming in the first mode, and then starting programming the data stored in at least one of the first data buffer or the second data buffer to the NVM in the second mode.

19. The method of claim 11, further comprising:
programming data stored in the write buffer to the NVM in the second mode, while programming the data stored in at least one of the first data buffer or the second data buffer to the NVM in the second mode.

20. The method of claim 11, wherein the controller is a solid state drive (SSD) controller system-on-chip (SoC).
